(19) United States
(12) Patent Application Publication
(10) Pub. No.: US 2009/0279625 A1
(43) Pub. Date: Nov. 12, 2009

(54) LEGACY-COMPLIANT BURST FORMATS FOR MULTIPLE USERS REUSING ONE SLOT (MUROS) OPERATION

(75) Inventors: Marian Rudolf, Montreal (CA); Stephen G. Dick, Nesconset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/437,056

(22) Filed: May 7, 2009

Related U.S. Application Data
(60) Provisional application No. 61/051,732, filed on May 9, 2008.

(51) Int. Cl. H04K 1/10

(52) U.S. Cl. 375/260

(57) ABSTRACT

A burst may include a three-bit tail sequence derived from a four-bit Enhanced General Packet Radio Service (EGPRS)-2 tail sequence. A legacy wireless transmit/receive unit (WTRU) may be multiplexed onto an Orthogonal Sub-channel (OSC) resource, and may receive a burst including four-bit Quadrature Phase Shift Keying (QPSK)-type tail sequences that decode to legacy three-bit Gaussian Minimum Shift Keying (GMSK)-type or 8PSK-type tail sequences. The legacy WTRU processes the tail sequences, unaware that the burst was received on an OSC sub-channel or that the tail sequences were encoded as QPSK-type tail sequences. An OSC QPSK tail sequence may be chosen such that it corresponds to the legacy GMSK tail sequence format when decoded on an OSC sub-channel, but also so that a power-versus-time mask, power constraint, or other criteria on the other MUROS sub-channel may be optimized. Different tail sequences may be used in OSC bursts, depending upon whether the WTRUs multiplexed onto a timeslot are legacy WTRUs or include OSC-specific features.

### CROSS REFERENCE TO RELATED APPLICATION

This application claims the benefit of U.S. Provisional Application No. 61/051,732, filed on May 9, 2008, which is incorporated by reference as if fully set forth.

### TECHNICAL FIELD

This disclosure relates to wireless communications.

### BACKGROUND

Various approaches have been developed to allow multiple users to reuse a single timeslot in time slotted wireless systems, referred to as Multiple Users Reusing One Slot (MUROS) technologies. One such approach involves the use of orthogonal sub-channels (OSC). OSC allows a wireless network to multiplex two wireless transmit/receive units (WTRUs) that are allocated the same radio resource (that is, time slot). In the uplink direction, the sub-channels are separated using non-correlated training sequences. The first sub-channel uses existing training sequences, and the second sub-channel uses new training sequences. Alternatively, only new training sequences may be used on both of the sub-channels. Using OSC enhances voice capacity with negligible impact to WTRUs and networks. OSC may be transparently applied for all Gaussian minimum shift keying (GMSK) modulated traffic channels (for example, for full rate traffic channels (TCH/F), half rate traffic channels (TCH/H), a related slow associated control channel (SACCH), and a fast associated control channel (FACCH)).

OSC increases voice capacity by allocating two circuit switched voice channels (that is, two separate calls) to the same radio resource. By changing the modulation of the signal from GMSK to QPSK (where one modulated symbol represents two bits), it is relatively easy to separate two users—one user on the X axis of the QPSK constellation and a second user on the Y axis of the QPSK constellation. A single signal contains information for two different users, each user allocated their own sub-channel.

In the downlink, OSC is implemented in a base station (BS) using a quadrature phase shift keying (QPSK) constellation that may be, for example, a subset of an 8-PSK constellation used for enhanced general packet radio service (EGPRS). Modulated bits are mapped to QPSK symbols (“dibits”) so that the first sub-channel (OSC-0) is mapped to the most significant bit (MSB) and the second sub-channel (OSC-1) is mapped to the least significant bit (LSB). Both sub-channels may use individual ciphering algorithms, such as A5/1, A5/2 or A5/3. Several options for symbol rotation may be considered and optimized by different criteria. For instance, a symbol rotation of 3π/8 would correspond to EGPRS, a symbol rotation of π/4 would correspond to π/4-QPSK, and a symbol rotation of π/2 can provide sub-channels to imitate GMSK. Alternatively, the QPSK signal constellation can be designed so that it appears like a legacy GMSK modulated symbol sequence on at least one sub-channel.

An alternate approach of implementing MUROS in the downlink involves multiplexing two WTRUs by transmitting two individual GMSK-modulated bursts per timeslot. As this approach causes increased levels of inter-symbol interference (ISI), an interference-cancelling technology such as Downlink Advanced Receiver Performance (DARP) Phase I or Phase II is required in the receivers. Typically, during the OSC mode of operation, the BS applies downlink and uplink power control with a dynamic channel allocation (DCA) scheme to keep the difference of received downlink and/or uplink signal levels of co-assigned sub-channels within, for example, a ±10 dB window, although the targeted value may depend on the type of receivers multiplexed and other criteria. In the uplink, each WTRU may use a normal GMSK transmitter with an appropriate training sequence. The BS may employ interference cancellation or joint detection type of receivers, such as a space time interference rejection combining (STIRC) receiver or a successive interference cancellation (SIC) receiver, to receive the orthogonal sub-channels used by different WTRUs.

OSC may or may not be used in combination with frequency-hopping or user diversity schemes, either in the downlink (DL), in the uplink (UL), or both. For example, on a per-frame basis, the sub-channels may be allocated to different pairings of users, and pairings on a per-timeslot basis may recur in patterns over prolonged period of times, such as several frame periods or block periods. Statistical multiplexing may be used to allow more than two users to transmit using two available sub-channels. For example, four WTRUs may transmit and receive their speech signals over a 6-frame period by using one of two sub-channels in assigned frames.

Further, different frequency-hopping sequences/Mobile Allocation Index Offsets (MAIOs) may be used by different WTRUs in a cell, such that each WTRU is paired with a different WTRU from timeslot to timeslot. The pattern used to define the WTRU pairings would repeat after a given number of frames. This technique could result in interference averaging and discontinuous transmission (DTX) gains for both OSC and non-OSC WTRUs.

For OSC in the UL, handsets may use Gaussian Minimum Shift Keying (GMSK) modulation. Each WTRU pair in a timeslot uses different training sequences to allow the two transmissions to be distinguished. Base stations may use either Space Time Interference Rejection Combining (STIRC) or Successive Interference Cancellation (SIC) to receive the UL OSC transmissions.

FIG. 1 shows an example legacy burst frame format. The legacy burst frame 100 includes a first tail sequence 102 of three bits at the beginning of the burst and a second tail sequence 110 of three bits towards the end of the burst. The frame 100 includes two sections 104, 108 for the payload data, each of which is fifty-eight bits in length. The frame also includes guard period 112. According to legacy operation, the tail bits are a known sequence in both a transmitter and a receiver. For example, in the case of GMSK-type bursts, the start and end tail sequences are encoded as (0; 0; 0). However, the phase rotations applied to bursts vary depending upon the modulation type employed. Therefore, regardless of the modulation type employed, the resulting complex symbol sequence in the tail sequence is still unique and uniquely known to the transmitter and the receiver. One of the challenges involved in the implementation of OSC is that earlier formats were designed for operating at a 271 kSym/sec symbol rate, while the QPSK-type burst called for in EGPRS-2 is designed for a 325 kSym/sec symbol rate.

FIG. 2 shows an example EGPRS-2 frame format. The EGPRS-2 frame 200 includes a first tail sequence 202 and a second tail sequence 210, each four bits in length. The frame 200 includes two sections 204, 208 for payload data, each of which is sixty-nine bits in length. The frame also includes a thirty-one bit training sequence 206 and a guard period 212. Contrary to the varying tail sequences used in EGPRS, the tail sequences for EGPRS-2 formats are fixed and known. For example, EGPRS-2 QPSK bursts use the sequence (0,0; 0,1; 1,1; 1,0), while 16-QAM bursts use (0,0,0,1; 0,1,1,0; 0,1,1,0; 1,1,0,1). Also different from earlier burst formats, the EGPRS-2 burst format includes four bits in the tail sequences 202, 210 instead of three.

Tail sequences define the start and end of a burst, and may be utilized as known states at the start and/or end of a trellis-based demodulator. In addition, the tail sequences are commonly used as demodulation aids in the context of timing and frequency correction techniques, automatic gain control (AGC), power estimation, and channel estimation. The selected tail sequence has an impact on the power-versus-time mask used for burst-by-burst power ramping.

When a WTRU receives a tail sequence with bits that do not correspond to the sequence expected for the corresponding burst type, WTRU performance may be degraded and the WTRU may react in an unpredictable manner detrimental to proper functioning of the network on which the WTRU is operating.

In order for a legacy WTRU to communicate in a timeslot where MUROS is used, the tail sequences of the QPSK bursts must correspond to the format expected by the legacy WTRU. Therefore, approaches are required to allows QPSK-type OSC bursts to employ tail sequences decodable by legacy equipment.

In addition, the tail sequences of QPSK OSC bursts must meet the requirements of power-versus-time masks and power constraints corresponding to the power level of the payload portions of the burst. Current technologies do not describe tail sequences for QPSK OSC bursts for use at the GSM legacy symbol rate. Therefore, tail sequences for such bursts are required.

### SUMMARY

A burst may include a three-bit tail sequence derived from a four-bit Enhanced General Packet Radio Service (EGPRS)-2 tail sequence. A legacy wireless transmit/receive unit (WTRU) may be multiplexed onto an Orthogonal Sub-channel (OSC) resource, and may receive a burst including four-bit Quadrature Phase Shift Keying (QPSK)-type tail sequences that decodes to legacy three-bit Gaussian Minimum Shift Keying (GMSK)-type or 8PSK-type tail sequences. The legacy WTRU processes the tail sequences, unaware that the burst was received on an OSC sub-channel or that the tail sequences were encoded as QPSK-type tail sequences. An OSC QPSK tail sequence may be chosen such that it corresponds to the legacy GMSK tail sequence format when decoded on an OSC sub-channel, but also so that a power-versus-time mask, power constraint, or other criteria on the other MUROS sub-channel may be optimized. Different tail sequences may be used in OSC bursts, depending upon whether the WTRUs multiplexed onto a timeslot are legacy WTRUs or include OSC-specific features.

### BRIEF DESCRIPTION OF THE DRAWINGS

A more detailed understanding may be had from the following description, given by way of example in conjunction with the accompanying drawings wherein:

FIG. 1 shows an example legacy burst frame format;

FIG. 2 shows an example EGPRS-2 frame format;

FIG. 3 is a functional block diagram of a wireless transmit/receive unit (WTRU) and a base station;

FIG. 4 is a signal diagram of a base station transmitting a burst with a QPSK-type tail sequence that decodes to a GMSK-type tail sequence; and

FIG. 5 shows a method for selecting a tail sequence based on whether WTRUs on a timeslot implement OSC features.

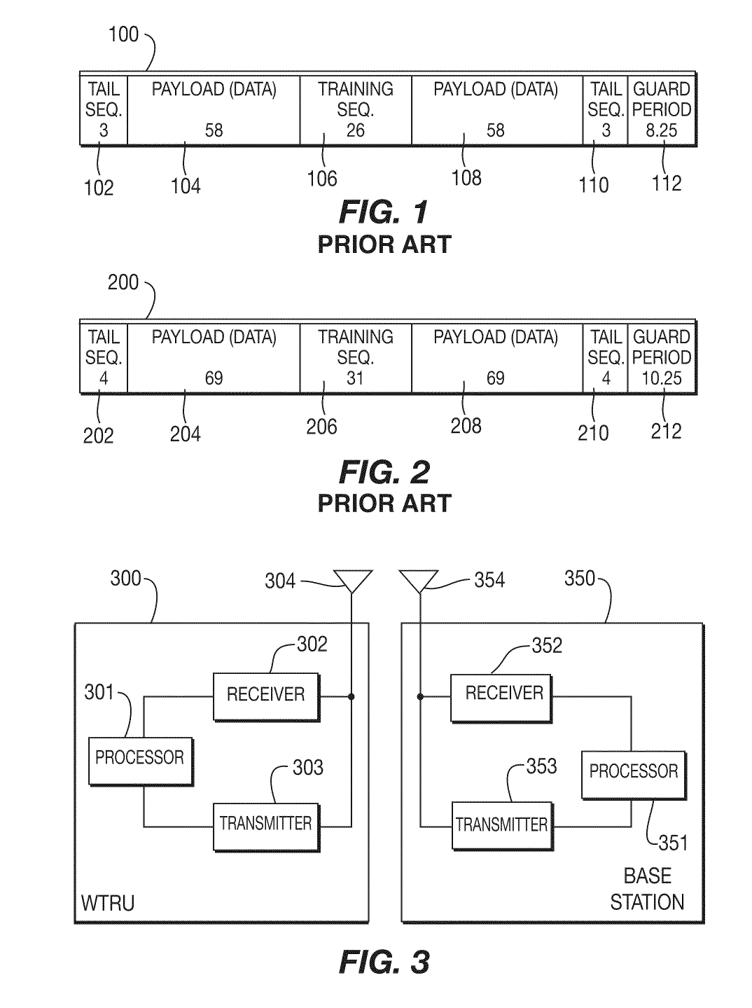

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, an evolved Node-B (eNB), a site controller, an access point (AP), or any other type of interfacing device capable of operating in a wireless environment. As used herein, a “legacy WTRU” refers to a WTRU that does not include features specific to MUROS operation. A legacy WTRU may include a receiver capable of using DARP Phase I or Phase II technology, and may be capable or receiving and/or transmitting data using Gaussian Minimum Shift Keying (GMSK), 8-Phase Shift Keying (PSK), or other modulation types. A legacy WTRU may receive and/or transmit data using MUROS technology, but does so using legacy-compliant burst formats as described herein. A “non-legacy WTRU,” “MUROS WTRU, “OSC WTRU,” or “OSC-capable WTRU” refers to a WTRU that implements MUROS and/or OSC-specific features, and may receive and/or transmit data using MUROS-specific burst formats and/or legacy-compliant burst formats. Additionally, MUROS WTRUs may be configurable to exchange MUROS-specific configuration parameters with a base station in order to facilitate MUROS communications.

The subject matter disclosed herein is applicable to all implementations of MUROS. They are applicable to, for example, approaches that use: (1) orthogonal sub-channels (OSCs) multiplexed signals by means of modulation, including QPSK modulation; (2) signals relying on interference-cancelling receivers which employ, for example, DARP technology; and (3) a combination of OSC and signals relying on interference-cancelling receivers. Additionally, although examples may be provided indicating a particular modulation type, the principles described herein may equally be applied to other modulation types, including GMSK, 8PSK, 16-Quadrature Amplitude Modulation (QAM), 32-QAM, and other modulation types.

FIG. 3 is a functional block diagram of a wireless communication system including a WTRU 300 and a base station (BS) 350. The WTRU 300 includes a processor 301 in communication with a receiver 302, transmitter 303, and antenna 304. The BS 350 includes a processor 351 in communication with a receiver 352, transmitter 353, and antenna 354. The WTRU 300 may include additional transmitters and receivers (not depicted) in communication with the processor 301 and antenna 304 for use in multi-mode operation, as well as other components described below.

An OSC QPSK burst may use a tail sequence derived from EGPRS-2 QPSK tail sequences, but employ three bits for each tail sequence instead of the four used in a standard EGPRS-2 QPSK burst. The overall duration of the transmission of three bits at the legacy rate of 271 kSym/sec symbol rate is the same as the duration of the transmission of four bits at the EGPRS-2 rate of 325 kSym/sec symbol rate. Accordingly, the same power-versus-time masks may be used for both the OSC QPSK and EGPRS-2 QPSK burst formats. One of ordinary skill in the art would appreciate that a number of suitable power-versus-time masks may be used for this purpose.

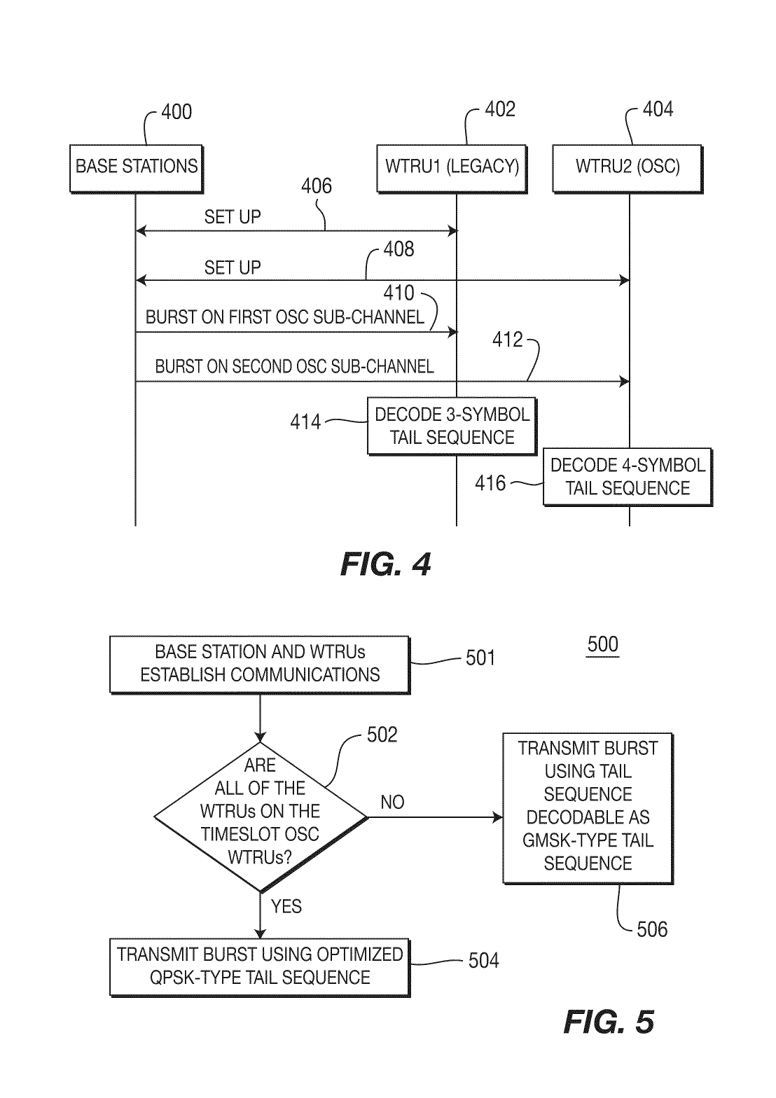

FIG. 4 is a signal diagram of a base station 400 transmitting a burst with a QPSK-type tail sequence that decodes to a GMSK-type tail sequence. The base station 400 and a first WTRU 402 perform 406 a resource assignment, registration, attachment, or other set up procedure to establish communications. This procedure may include the base station 400 determining that the first WTRU 402 is a legacy WTRU. This procedure may include the base station 400 determining that the first WTRU 402 is a legacy WTRU. The determination may be made based on a message indicating capabilities received from the first WTRU 402 during performance 406 of the set up procedure. The message may include one or more capability fields that explicitly indicate that the WTRU does not implement OSC functionality. Alternatively, the message may be silent regarding OSC capabilities and the base station 400 may interpret the message to indicate a lack of OSC capabilities. The base station 400 and second WTRU 404 also perform 408 a set up procedure. This procedure may include the base station 400 determining that the second WTRU 404 is an OSC WTRU. The determination may be made based on a message received from the second WTRU 404 during performance 408 of the set up procedure including one or more fields indicating OSC capabilities.

The base station 400 generates a first QPSK-type burst intended to be received by the first WTRU 402, and transmits 410 the first burst to the first WTRU 402 on a first OSC sub-channel. The base station 400 generates a second QPSK-type burst intended to be received by the second WTRU 404, and transmits 412 the second burst to the second WTRU 404 on a second OSC sub-channel. The first WTRU 402 decodes 414 the tail sequence of the burst as if it were a GMSK-type tail sequence. Because the first burst included a QPSK-type tail sequence as described above and because the first WTRU 402 is a legacy WTRU, the first WTRU 402 decodes 414 the tail sequence to the appropriate GMSK-type sequence. The second WTRU 404 decodes 416 the tail sequence as a QPSK-type sequence. Using the signaling shown in FIG. 4, the first WTRU 402 and second WTRU 404 can operate on the same timeslot, the first WTRU 402 decoding QPSK-modulated data using GMSK and the second WTRU 404 decoding QPSK-modulated data using QPSK.

Various tail sequences may be used in combination with the signaling shown in FIG. 4. For example, the base station 400 may modulate a burst with a four-bit tail sequence using QPSK, such that the first WTRU 402 may demodulate the burst using GMSK, take phase rotations into account, and decode the four-bit tail sequence as a three-bit tail sequence. The three-bit tail sequence may be any suitable GMSK tail sequence known in the art including, but not limited to, (0; 0; 0) and alternative representations of (0; 0; 0).

The four-bit tail sequences used by the base station 400 may be determined in a variety of ways. For example, the base station 400 may map a four-bit tail sequence in a QPSK constellation to a binary bit sequence in a GMSK constellation. Additionally or alternatively, a portion or all of an OSC QPSK tail sequence may be chosen such that it corresponds to the legacy GMSK tail sequence format when decoded on an OSC sub-channel, but at the same time optimizes a parameter such as a power-versus-time mask or power constraint on the other MUROS sub-channel. The determination of the optimal tail sequence may be performed by the base station 400 prior to or during the generation of the bursts that include the tail sequence.

FIG. 5 shows a method 500 where different tail sequences may be used depending upon the kinds of WTRUs that are multiplexed onto a timeslot. For example, a first MUROS QPSK tail sequence may be employed when a legacy WTRU is multiplexed onto an OSC sub-channel, but a second MUROS QPSK tail sequence is employed on MUROS bursts when no legacy equipment is multiplexed onto the timeslot. A base station and two or more WTRUs establish 501 communications through resource assignment, registration, attachment, or other set up procedures. At the base station, a determination is made 502 as to whether the WTRUs that may be multiplexed onto a timeslot are OSC or legacy WTRUs. The determination may be made based on, for example, messages indicating capabilities received from the WTRUs. Capability message may include one or more fields that explicitly indicate whether a WTRU implements OSC functionality. Alternatively, a message may be silent regarding OSC capabilities and the base station may interpret the message to indicate a lack of OSC capabilities. If all of the WTRUs are OSC WTRUs, then an optimized QPSK-type tail sequence may be used to transmit 504 bursts on the timeslot. Where one or more legacy WTRUs are found, a QPSK-type tail sequence that may be decoded by a legacy WTRU as a GMSK-type tail sequence may be used to transmit 506 bursts on the timeslot.

Referring again to FIG. 3, the processors 301, 351 are configurable to generate and decode the messages, signals, and bursts as described above with respect to FIGS. 4 and 5. The transmitters 303, 353 and receivers 302, 352 are configurable to send and receive, respectively, the messages, signals, and bursts as described above with reference to FIGS. 4 and 5. The subject matter disclosed above may be employed in wireless systems where frequency-hopping is used or in systems where WTRU OSC pairings are changed on a per-frame basis. The OSC sub-channels described above may be implemented on the QPSK in-phase or quadrature component, or through a bit-to-symbol mapping process. Additionally, the subject matter disclosed above with reference to GMSK-type burst formats is also applicable, mutatis mutandis, to legacy equipment using 8PSK-type burst formats.

Although features and elements are described above in particular combinations, each feature or element can be used alone without the other features and elements or in various combinations with or without other features and elements. The methods or flow charts provided above may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A base station, comprising:
a processor configured to generate a first four-bit tail sequence to be decoded to a first length and a second four-bit tail sequence to be decoded to a second length; and
a transmitter configured to transmit a first burst including the first tail sequence to a first wireless transmit/receive unit (WTRU) on a first Orthogonal Sub-channels (OSC) sub-channel on a timeslot, and to transmit a second burst including the second tail sequence to a second WTRU on a second OSC sub-channel on the timeslot.

2. The base station of claim 1 wherein the first length is three bits and the second length is four bits.

3. The base station of claim 1 wherein the processor is further configured to modulate the first and second bursts using Quadrature Phase Shift Keying (QPSK).

4. The base station of claim 1 wherein the processor is configured to generate the first and second tail sequences by selecting tail sequence values to optimize a power control parameter for the second WTRU.

5. The base station of claim 3 wherein the power control parameter is a power-versus-time mask.

6. The base station of claim 3 wherein the power control parameter is a power constraint.

7. The base station of claim 1 wherein the processor is configured to generate the first tail sequence by mapping from a Quadrature Phase Shift Keying (QPSK) constellation to a Gaussian Minimum Shift Keying (GMSK) constellation.

8. The base station of claim 1 further comprising:
a receiver configured to receive a first message from the first WTRU indicating that the first WTRU is OSC-capable and to receive a second message from the second WTRU indicating that the second WTRU is OSC-capable;
wherein the processor is configured to generate the first and second tail sequences based on the first and second messages.

9. The base station of claim 8 wherein the receiver is configured to receive the first message during an attach procedure with the first WTRU and to receive the second message during an attach procedure with the second WTRU.

10. The base station of claim 1 wherein the transmitter is configured to transmit the first burst and the second burst via a Global System for Mobile Communications (GSM) Enhanced Data Rates for GSM Evolution (EDGE) Radio Access Network (GERAN).

11. A base station, comprising:
a processor configured to:
determine whether a first wireless transmit/receive unit (WTRU) multiplexed on a timeslot is Orthogonal Sub-channels (OSC)-capable and whether a second WTRU multiplexed on the timeslot is OSC-capable; and
on a condition that the first and second WTRUs are OSC-capable, select a first four-bit tail sequence; and
on a condition that the first WTRU is OSC-capable and that the second WTRU is not OSC-capable, select a second four-bit tail sequence that is decodable by the first WTRU as a four-bit tail sequence and by the second WTRU as a three-bit tail sequence; and
a transmitter configured to transmit a burst to the first WTRU using the selected first or second tail sequence.

12. The base station of claim 11 wherein the transmitter is further configured to modulate the burst using Quadrature Phase Shift Keying (QPSK).

13. The base station of claim 11 further comprising:
a receiver configured to receive a first message from the first WTRU indicating whether the first WTRU is OSC-capable and to receive a second message from the second WTRU indicating whether the second WTRU is OSC-capable;
wherein the processor is configured to determine whether the first WTRU is OSC-capable based on the first message; and
wherein the processor is configured to determine whether the second WTRU is OSC-capable based on the second message.

14. The base station of claim 13 wherein the receiver is configured to receive the first message during an attach procedure with the first WTRU and to receive the second message during an attach procedure with the second WTRU.

15. The base station of claim 11 wherein the transmitter is configured to transmit the burst via a Global System for Mobile Communications (GSM) Enhanced Data Rates for GSM Evolution (EDGE) Radio Access Network (GERAN).

16. A wireless transmit/receive unit (WTRU), comprising:
a receiver, configured to receive a burst on an Orthogonal Sub-channels (OSC) sub-channel encoded with Quadrature Phase Shift Keying (QPSK) and including a four-bit tail sequence; and
a processor, configured to decode the burst, the decoded burst including a three-bit tail sequence.

17. The WTRU of claim 16 wherein the processor is configured to decode the burst using Gaussian Minimum Shift Keying (GMSK).

18. The WTRU of claim 16 wherein the processor is configured to decode the burst using 8 Phase Shift Keying (8PSK).

19. The WTRU of claim 16 wherein the three-bit tail sequence is (0; 0; 0).

20. The WTRU of claim 16 wherein the receiver is configured to receive the burst via a Global System for Mobile Communications (GSM) Enhanced Data Rates for GSM Evolution (EDGE) Radio Access Network (GERAN).
